(19) United States
(12) Patent Application Publication
(10) Pub. No.: US 2003/0033233 A1
(43) Pub. Date: Feb. 13, 2003

(54) Evaluating an organization's level of self-reporting

(76) Inventors: Janice M. Lingwood, London (GB); Paul J. Evans, Tunbridge Wells (GB); Andrew H. Cantos, North Wales, PA (US); Annette Watson, Victoria (AU); Philip P. Ashton, Kingston-upon Thames (GB)

Correspondence Address: FISH & RICHARDSON P.C., 45 ROCKEFELLER PLAZA, SUITE 2800, NEW YORK, NY, 10111, US

(21) Appl. No.: 10/080,846

(22) Filed: Feb. 22, 2002

Related U.S. Application Data
(60) Provisional application No. 60/307,482, filed on Jul. 24, 2001.

(51) Int. Cl. G06F 17/60; G09B 19/18; G06F 11/30; G06F 15/00; G21C 17/00; G09B 3/00; G09B 7/00

(52) U.S. Cl. 705/36; 705/10; 705/14; 702/182; 434/353; 434/107

(57) ABSTRACT

A software-based tool provides an evaluation of a company's level of reporting about itself. The tool can, in some cases, provide an assessment of a company's communications against a framework that assumes transparent reporting is desirable. A comparison with pre-selected criteria such as a pre-selected peer group of companies or against a set of recommended practices may be provided in some implementations. Based on the results of the analysis, a score can be generated for different areas of the framework. The scores can be summarized in an executive level presentation that may include, in some implementations, benchmark results against the framework and the pre-selected criteria, identification of best practice examples, and recommendations for improvement.

### CROSS-REFERENCE TO RELATED APPLICATIONS

This application claims the priority of U.S. Provisional Patent Application Serial No. 60/307,482, filed on Jul. 24, 2001, which is incorporated herein by reference.

### BACKGROUND

The disclosure relates to evaluating an organization's level of self-reporting.

Executives often find themselves trying to manage expectations about their organization's earnings. As a result, some companies may disclose information about the company required by regulation, but little non-financial information that investors and other stakeholders seek. For example, in the context of a publicly traded company, the information disclosed may reveal little about future stock price performance and may lead to excessive stock price volatility, inaccurate valuations and over-reliance on market gossip. Adequate information about intangible assets and nonfinancial value drivers-which can serve as leading indicators of future financial success-are often missing from such traditional financial reporting.

### SUMMARY

A software-based tool provides an evaluation of a company's level of reporting about itself. The tool can provide an assessment of a company's communications against a framework that assumes transparent reporting is desirable. A comparison with pre-selected criteria, such as a pre-selected peer group of companies or a set of recommended practices may be provided in some implementations. Based on the results of the analysis, a score can be generated for each area of the framework. In some implementations, the scores may be summarized in an executive level presentation that can include benchmark results against the framework and the pre-selected criteria, identification of best practice examples, and recommendations for improvement.

In one aspect, a method includes entering information in a computer system with respect to performance measures indicative of an organization's level of reporting about itself and causing the computer system to generate an assessment of the organization's level of reporting based on the received information.

According to some implementations, publicly available sources of an organization's external communications are examined. Information is entered on a questionnaire with respect to performance measures based on the examined sources to provide an indication of the organization's level of external reporting about itself. An assessment of the organization's level of external reporting is received from a computer system based on the information entered on the questionnaire.

The detailed description also discloses an apparatus that includes a database to store templates for one or more questionnaires for use in connection with scoring performance measures based on an organization's level of reporting about itself. A processor is coupled to the database. Memory includes instructions that, when applied to the processor, cause the processor to provide a questionnaire based on the templates, and to generate an assessment of the particular organization's level of reporting about itself based on information entered on the questionnaire by a user.

The techniques, described in greater detail below, can help an organization become more informed about the extent and types of information it disseminates to the public about itself. An assessment of how well the organization performs can help the organization address deficiencies in its external reporting.

The techniques also can be used to assist the organization in understanding how well it communicates information to employees, management and other stakeholders within the organization.

Other features and advantages will be readily apparent from the following detailed description, the accompanying drawings and the claims.

### BRIEF DESCRIPTION OF THE DRAWINGS

FIG. 1 is a block diagram of a system that includes a tool for evaluating an organization's level of reporting.

FIGS. 2A though 2E illustrate portions of a questionnaire for use in the evaluation.

FIG. 3 is a flow chart of a method of evaluating an organization's level of reporting.

FIG. 4 illustrates an example of a completed questionnaire.

FIG. 5 is a chart showing examples of communication types and the corresponding number of points that are awarded in one implementation.

FIG. 6 is a chart illustrating an example of calculating total scores for a performance measure.

FIG. 7 is a radar diagram comparing an organization's score against recommended practices.

### DETAILED DESCRIPTION

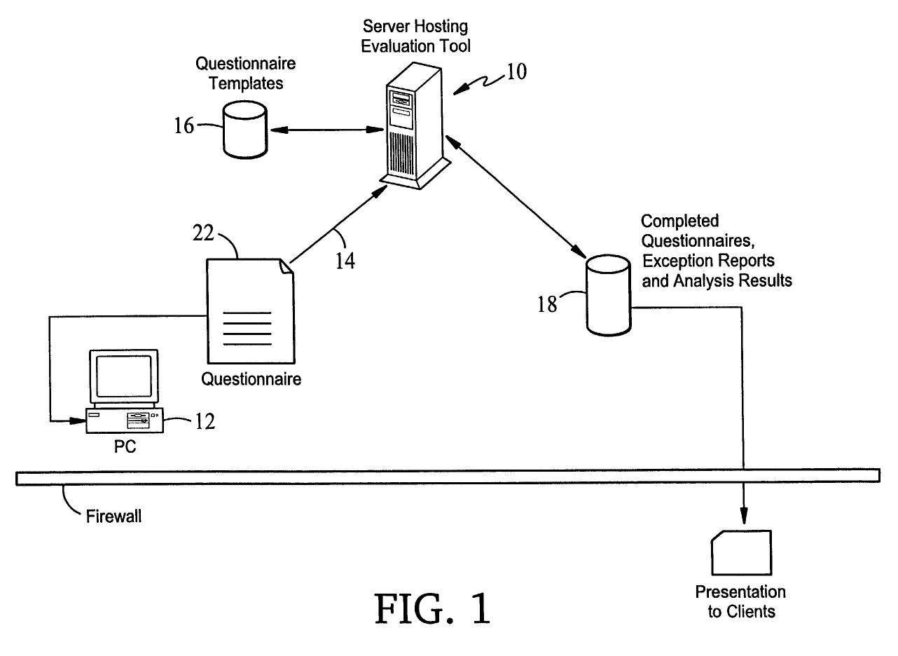

As shown in FIG. 1, a system includes an evaluation tool hosted, for example, on a server 10 that can be accessed from a personal computer 12 over the Internet or other network 14. A database 16 is associated with the server 10 and stores templates for generating questionnaires 22. Results of the evaluation can be stored in another database 18. The results can be displayed and subsequently presented to the evaluated organization. In some implementations, the evaluated organization may be given access to the results through an Extranet or through on-line subscription rights.

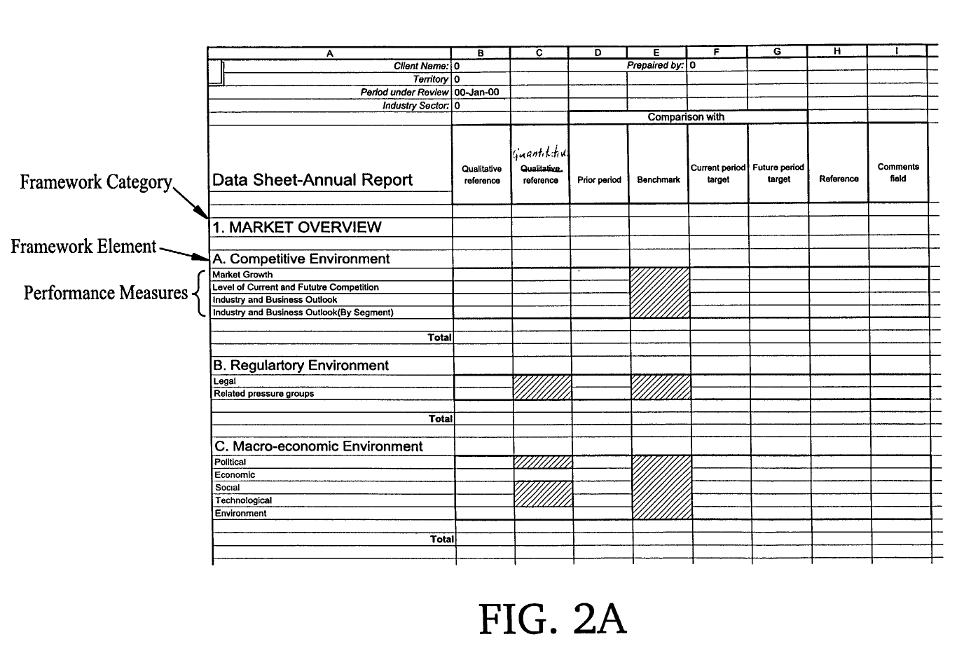

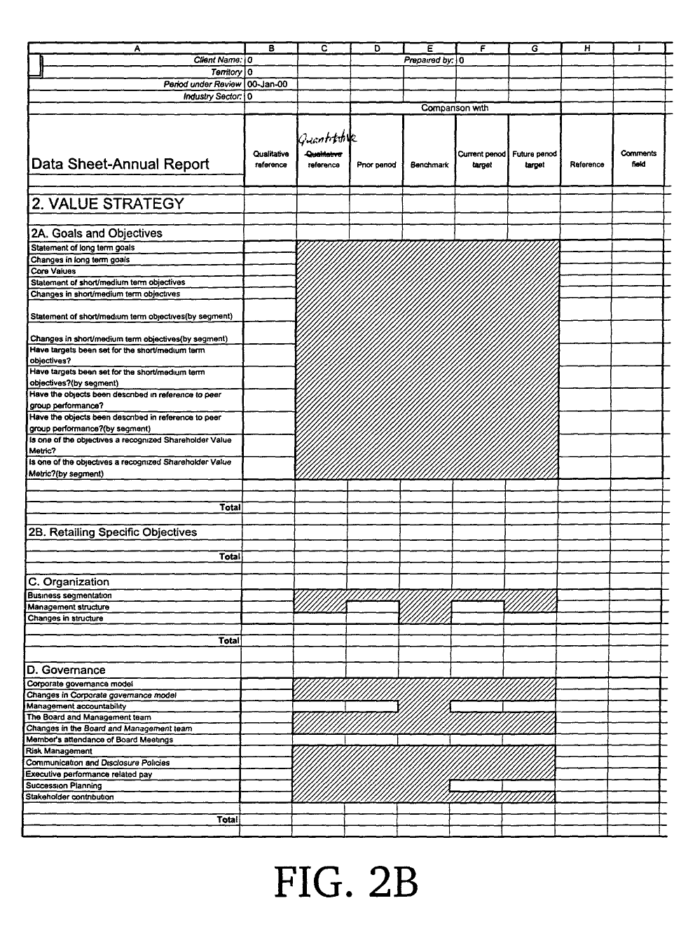

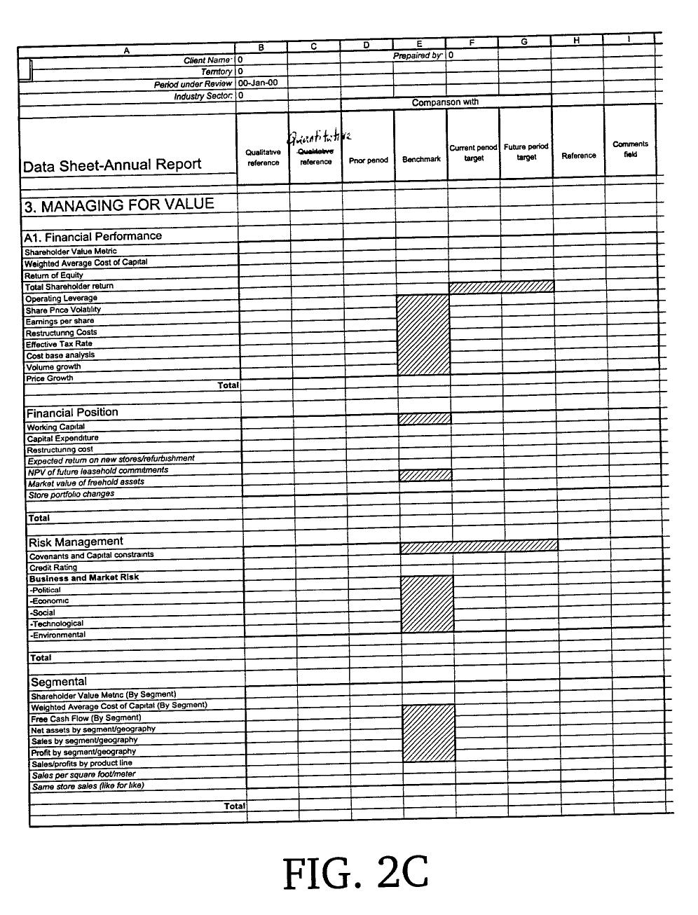

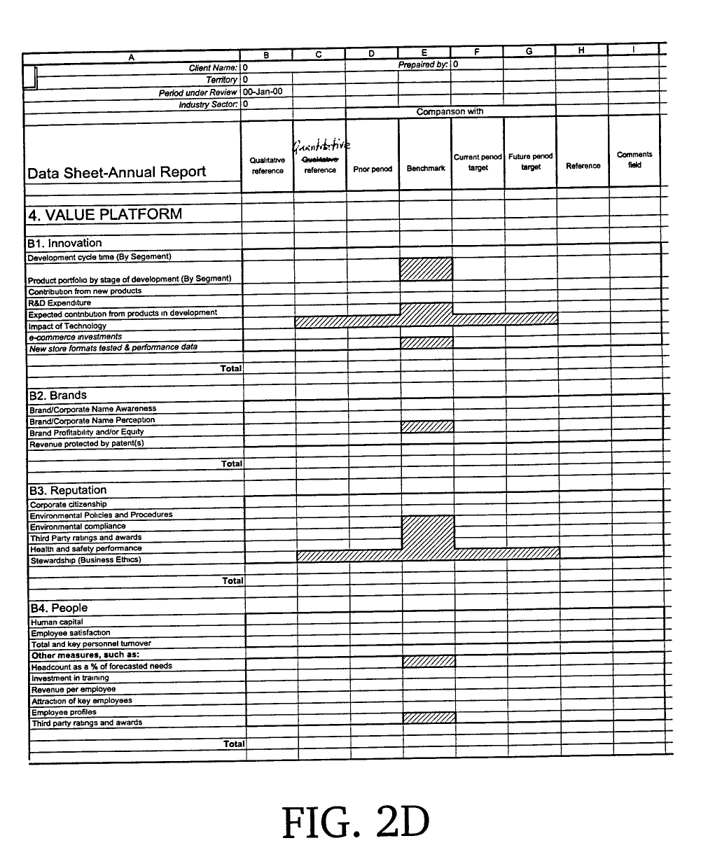

As shown in FIGS. 2A through 2E, in one particular implementation, the organization is scored against a framework that includes the following categories: Market Overview (FIG. 2A), Value Strategy (FIG. 2B), Managing for Value (FIG. 2C) and Value Platform (FIGS. 2D and 2E). The Market Overview category relates to management's assessment of the company's competitive position, assumptions about the macro-economic environment and industry growth, views on regulatory environment and perceptions about current and future technologies. The Value Strategy category relates to the company's overall corporate strategy and its strategies for major business units, as well as how the company intends to implement those strategies in terms of organization and governance, structures and processes. The Managing for Value category relates to the measures that the company believes most closely reflect determinants of and changes in shareholder value. The Value Platform category relates to information on non-financial value drivers such as innovation, intellectual capital, customers, brands, supply chain, people and reputation.

Each category in the framework has one or more elements each of which has a respective suite of performance measures associated with it. In this example, the performance measures serve as predictive indicators of future shareholder value creation. In general, the performance measures represent information that may be used by management, investors, analysts and others to gain an understanding of the organization's performance in financial and non-financial areas.

In the example illustrated by FIG. 2A, the category Market Overview includes the elements Competitive Environment, Regulatory Environment and Macro-Economic Environment. In this example, the element Competitive Environment relates to external constituents and dynamics that impact the current or future business environment, including customers, suppliers, competitors, globalization and new technologies. That element has the following performance measures: Market Growth, Level of Current and Future Competition, Industry and Business Outlook and Industry and Business Outlook (by segment). The performance measure Market Growth, for example, refers to the increase in size of the total market as defined by the organization. The elements and performance measures in the questionnaire illustrated in FIGS. 2A through 2E are intended as examples.

The database 16 stores templates for questionnaires to be used with the evaluation tool. To initiate an evaluation, a user accesses the evaluation tool, for example, from the personal computer 12. In some implementations, the evaluation tool may be accessed through a web page. After accessing the evaluation tool, the user enters information about the organization to be evaluated in response to prompts from the evaluation tool. The evaluation tool generates questionnaires based on the templates in the database 16 and the information provided by the user. The questionnaires are sent to the user for display on the personal computer 12.

One implementation uses the following three questionnaires: an Annual Report Questionnaire (ARQ), an Investors Briefing Questionnaire (IBQ) and an Other Media Questionnaire (OMQ). In this particular example, the questionnaires are designed to capture information reported externally by the organization. For example, the ARQ identifies information obtained from the organization's annual report. Portions of the ARQ are illustrated in FIGS. 2A through 2E. The IBQ identifies information from presentations and reports to analysts or investors, from speeches and from question and answer sessions held by the organization. Similarly, the OMQ identifies information from environmental reports, social impact reports, press releases and the organization's website. The IBQ and OMQ can have a format similar to the format of the ARQ shown in FIGS. 2A-2E.

In other implementations, the questionnaires can be designed to help determine the level of the organization's reporting about itself to its employees or other stakeholders.

Some implementations allow the user to add or delete elements and performance measures from the questionnaires. Thus, the questionnaires may be tailored to the particular organization that is to be evaluated.

Information reported by the organization about itself may be presented qualitatively through a narrative description or quantitatively through the use of numbers, statistics, percentages, graphs, etc. As illustrated by FIGS. 2A-2E, the questionnaires list six ways-or communication types-in which information may be presented: 1. Qualitative information (QL); 2. Quantitative information for the current period (QN-C); 3. Quantitative information for a prior period (QN-PP); 4. Benchmarking information (QN-BM); 5. Quantitative target information for the current period (QN-CT); and 6. quantitative target information for a future period (QN-FT). The second through sixth communication types are represented by quantitative information.

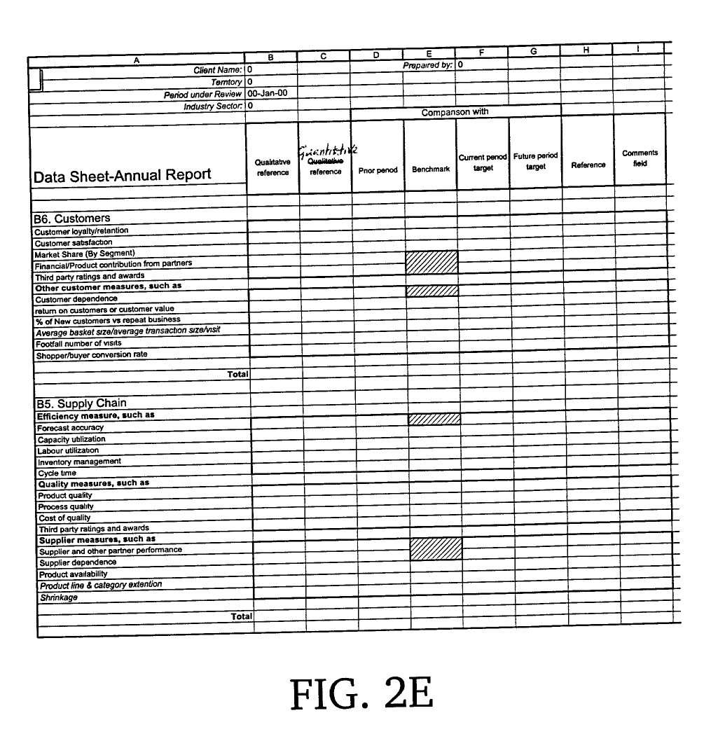

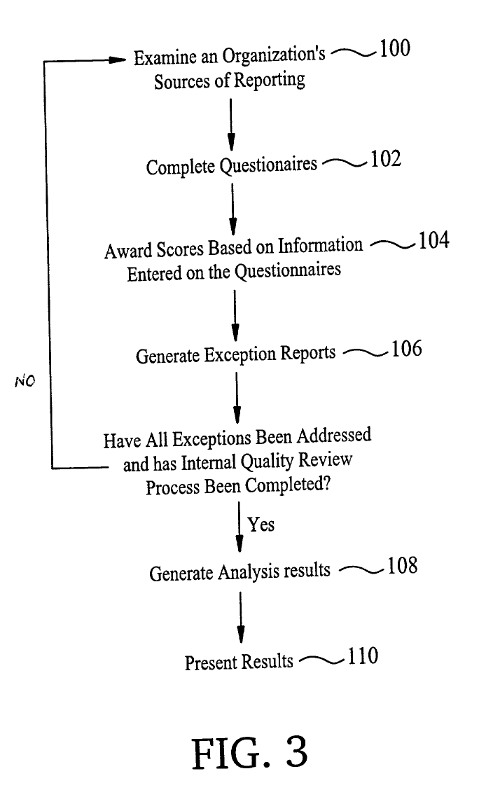

As indicated by FIG. 3, as part of the evaluation process, one or more persons, referred to as scorers, examine 100 all relevant available sources of reporting by the organization and complete 102 the questionnaires. For example, if the goal of the evaluation is to determine the organization's level of reporting about itself to the public, publicly available sources of external information by the organization would be examined. Information about the various performance measures listed in the questionnaires is identified. If information relating to a particular performance measure is disclosed in the examined sources, the scorer enters “YES” in the appropriate box on the questionnaire. If the scorer does not find any information for a particular communication type, then “NO” is entered in the appropriate box. Preferably, data for a performance measure that is not explicitly mentioned in the organization's reporting should not receive a positive score even though the data can be calculated from the other disclosed information.

Communication types that are inapplicable for a particular performance measure are blocked out on the questionnaire and need not be scored. In the illustrated implementation, for example, a benchmark for the performance measure Market Growth listed under the element Competitive Environment in the category Market Overview is inapplicable and, therefore, has been blocked out (FIG. 2A).

According to one implementation, the ARQ and IBQ should be completed before the OMQ. When the scorer accesses the OMQ, the evaluation tool automatically indicates which performance measures received a non-zero score during completion of the ARQ and IBQ. Thus, the scorer need only address the remaining performance measures when completing the OMQ. For example, a press release may explain the company's strategy which also was disclosed in the company's annual report. In that case, no additional score would need to be entered on the OMQ in connection with the corresponding performance measure.

As shown, for example, in FIG. 2A, each questionnaire includes a column (“Reference”) to allow the scorer to list or cross-reference the source of the data. Preferably, two-way referencing should be used. The specific source of the information that serves as the basis for the score can be listed in the Reference column. Additionally, the questionnaire, the performance measure and the communication type(s) that were awarded a non-zero score can be noted on the document itself.

As also shown, for example, in FIG. 2A, each questionnaire includes a Comments column that allows the scorer to provide additional comments. One group of comments-permanent comments-may specify what information was communicated in the examined sources as well as recommendations for improvement. A second group of comments-transitory comments-can relate to issues that need to be addressed with other members of a team assisting in the evaluation. The different types of comments can be entered in separate fields of the Comments column. The information in those columns can be used to confirm the scoring is accurate and to facilitate quality control. The evaluation tool can delete transitory comments automatically from the questionnaires after they have been reviewed and addressed.

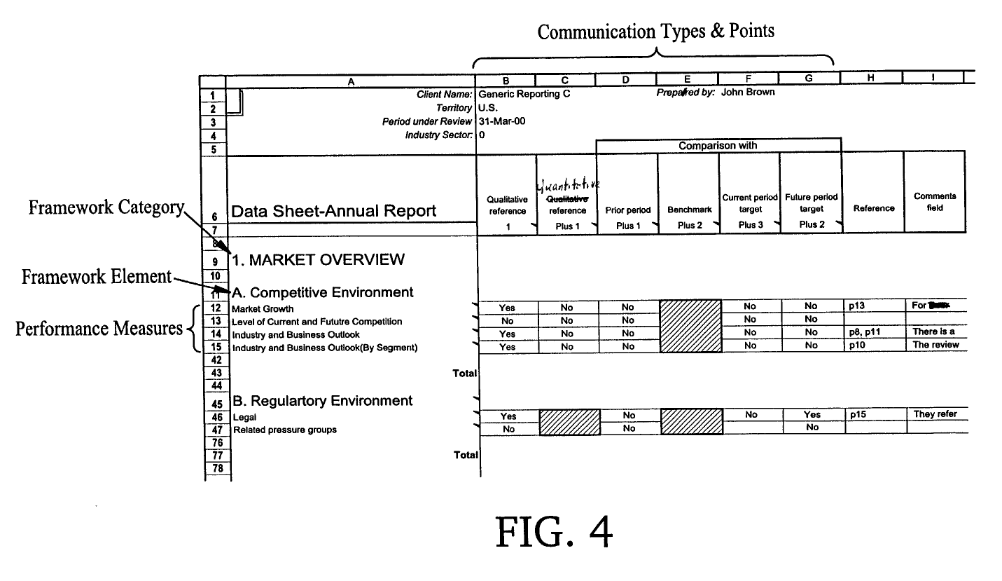

FIG. 4 illustrates an example of a completed questionnaire.

Where quantitative information is provided in the company's reports for only a specific sector or geographical segment of the business, such information may be considered sufficient to generate a non-zero score for the relevant performance measure. In that situation, comments can be provided in the Comments column (e.g., FIG. 2A) to indicate the proportion of the business for which the information was provided. A comment also can be added recommending that such data be provided for all sectors of the business.

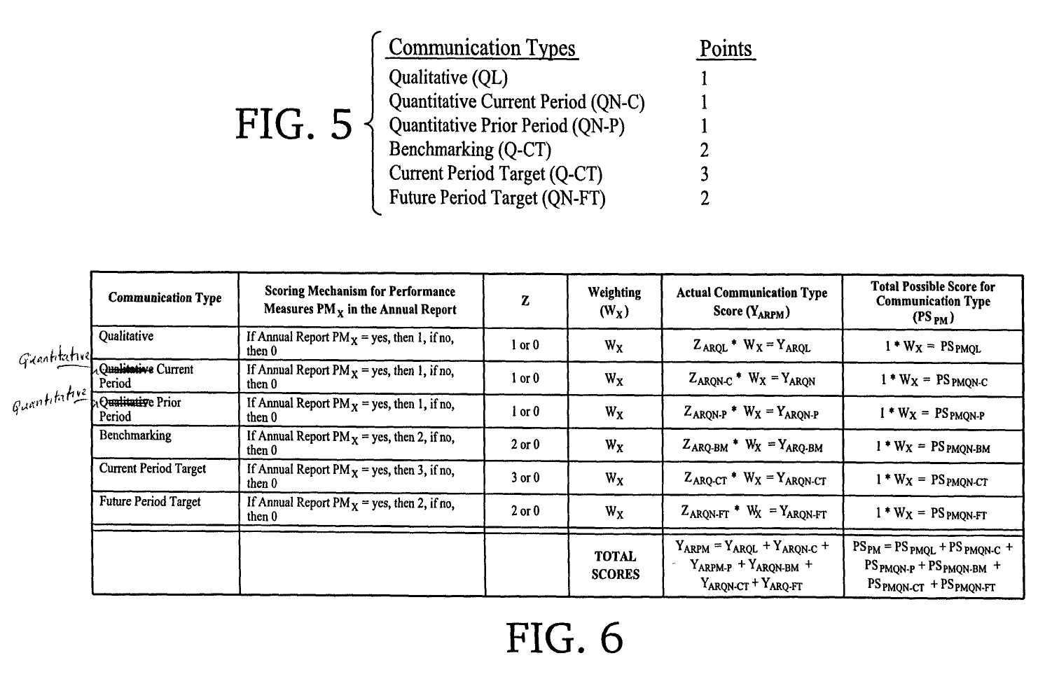

After entering the information on the questionnaire(s), the user would, for example, click an appropriate graphical user interface on the computer screen associated with the computer 12 to cause the evaluation tool to perform the evaluation. The evaluation tool automatically awards 104 (FIG. 3) a score for each performance measure in the questionnaires based on whether the performance measure is communicated in one or more of the six defined communication types in the source being reviewed. FIG. 5 lists the number of points that are awarded for each communication type according to one implementation. The number of points awarded for a particular performance measure and communication type is the same regardless of whether the same type of information appears only once or more than once in the organization's external reporting.

Typically, quantitative information is accompanied by qualitative information in the form of narrative. Therefore, in some implementations, the evaluation tool automatically generates a qualitative score for a particular performance measure when a non-zero score is entered for a non-qualitative communication type with respect to the same performance measure.

In the illustrated example, the maximum score that the organization can receive in connection with a particular performance measure is “10.” That score would be awarded if the organization's reporting disclosed information in each of the communication types in connection with a particular performance measure.

Once the performance scores are entered into the questionnaires, the evaluation tool automatically calculates a total score for each element in the framework with respect to each of the communication types.

A quality control process can be used to help assure that each organization is scored accurately and consistently. In one implementation, the quality control process includes three levels of review: scorer review, engagement review and core team review. At each level of review, the evaluation tool automatically generates 106 (FIG. 3) an exception report.

Exceptions may be generated, for example, if a quantitative score is obtained for a “stretch measure.” A stretch measure refers to a performance measure for which there is no general agreement as to how that performance measure should be calculated. Examples of stretch measures include human capital, quality of management and corporate citizenship. An exception is generated if a quantitative score is provided for such a performance measure.

An exception also may be generated with respect to performance measures required by international accounting or other standards, but for which no score was generated. Similarly, an element in the framework having a total score of zero will cause an exception to be generated. Additionally, an exception can be generated if the score for a particular framework element falls outside an expected range, for example, if the score is unexpectedly high or low. In particular implementations, additional or different exceptions may be generated automatically by the evaluation tool.

Once the questionnaires and the quality review process are completed, the evaluation tool generates 108 (FIG. 3) analysis results based on the received information. A total score or rating indicative of the organization's level of reporting about itself can be generated. The organization may receive a rating that indicates the extent to which the organization's overall reporting is considered transparent. In one implementation, a rating of “1” would indicate that the organization's level of reporting about itself is excellent, whereas a rating of “5” would indicate that the organization's level of reporting is very poor and that significant improvement is recommended. Ratings of “2,” “3” or “4” would indicate levels of reporting that fall somewhere between the high and low ratings.

In addition, a total score for each performance measure can be calculated. The analysis results can include the organization's total score for each category and each element in the framework, and the total scores can be compared to the corresponding highest possible scores.

FIG. 6 illustrates one technique for calculating the organization's actual total score for a performance measure and the maximum possible score for that performance measure. In the table of FIG. 6, PMₓ refers to the x^{th} performance measure and Z indicates the possible number of points awarded. Wₓ indicates the weighting for the x^{th} performance measure. Typically, Wₓ is assigned a value of 1. However, different values may be assigned so that different performance measures carry a different weight in the overall calculations.

In some implementations, different sources of reporting by the organization may receive different weights. For example, if some sources tend to be more important in a particular industry, those sources could be weighted more heavily when evaluating an organization in that industry. Similarly, certain elements in the framework may be weighted more heavily if those elements are more significant for the specific industry to which the organization to be evaluated belongs.

A total score for a particular element in the framework can be obtained by calculating the sum of the total scores for each of the performance measures in that element. Similarly, a total score for a particular category can be obtained by calculating the sum of the total scores for each element in that category. Comparisons of the organization's actual scores to the maximum possible scores can be calculated as well.

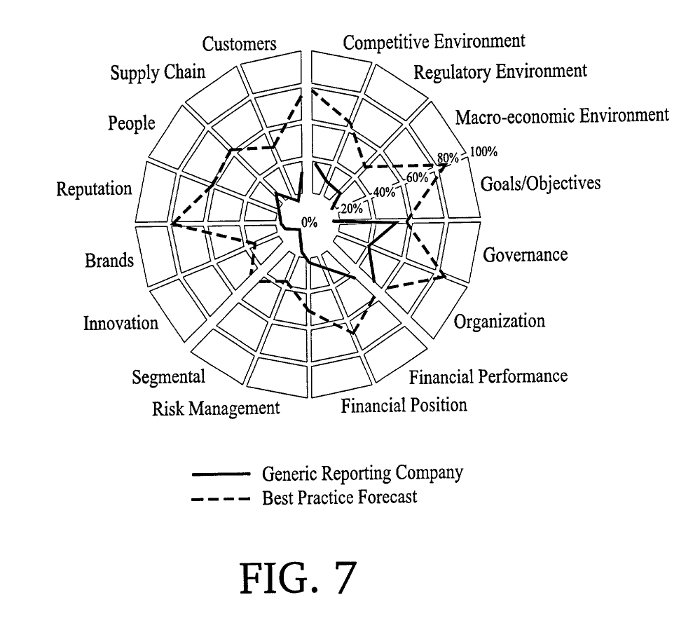

The organization's score can be presented alone, compared to previously determined best or recommended practices, or to a peer group of one or more companies. In general, the assessment of the organization's level of reporting about itself can include a comparison to some pre-selected criteria. The results can be presented in various formats including charts or radar diagrams. The user of the evaluation tool can select the particular format in which the results are to be displayed. For example, FIG. 7 illustrates a radar diagram that plots the score for an organization around each element of the framework. Such diagrams can be generated automatically to display the organization's score against a peer group for all three questionnaires or individually by questionnaire. The peer group can be selected, for example, based on industry, geography or market capitalization. The various formats summarize the effectiveness of the organization's communications about itself.

Various features of the system can be implemented in hardware, software, or a combination of hardware and software. For example, some features of the system can be implemented in computer programs executing on programmable computers. Each program can be implemented in a high level procedural or object-oriented programming language to communicate with a computer system. Furthermore, each such computer program can be stored on a storage medium such as read-only-memory (ROM) readable by a general or special purpose programmable computer or processor, for configuring and operating the computer to perform the functions described above.

Various options can be made available to a user through the use of drop-down menus or graphical user interfaces to allow the user to select, for example, the desired questionnaires and criteria against which the organization is to be assessed.

The foregoing implementations, including details of the questionnaires, the communication types and points awarded, as well as the calculations used to obtain total scores, are intended as examples only. Other implementations are within the scope of the claims.

What is claimed is:

1. A method comprising:
entering information in a computer system with respect to performance measures indicative of an organization's level of reporting about itself; and
causing the computer system to generate an assessment of the organization's level of reporting based on the received information.

2. The method of claim 1 including causing the computer system to generate an assessment of the organization's level of reporting about itself compared to pre-selected criteria.

3. The method of claim 2 including causing the computer system to generate an assessment of the organization's level of reporting about itself compared to a pre-selected industry.

4. The method of claim 2 including causing the computer system to generate an assessment of the organization's level of reporting about itself compared to a pre-selected peer group.

5. The method of claim 1 including causing the computer system to generate an assessment of the organization's level of reporting about itself compared to recommended practices.

6. The method of claim 1 including:
causing the computer system to provide one or more questionnaires listing the performance measures;
entering information indicative of the organization's level of reporting on the questionnaires; and
causing the computer system to generate the assessment based on the information entered on the questionnaires

7. The method of claim 6 including causing the computer system to provide multiple questionnaires each of which corresponds to a different source of communications by the organization.

8. The method of claim 7 including causing the computer system to generate a separate assessment of the organization's level of reporting for each questionnaire.

9. The method of claim 1 including causing the computer system to generate an assessment that includes scores for subsets of the performance measures.

10. The method of claim 1 wherein points are awarded separately for quantitative and qualitative information that reflects the organization's level of reporting with respect to the performance measures.

11. The method of claim 10 wherein different numbers of points are awarded for different types of quantitative information.

12. The method of claim 10 wherein a number of points for a particular performance measure are awarded based on whether information that corresponds to the particular performance measure that was reported by the organization relates to a past, present or future time period.

13. The method of claim 1 including causing the computer system to generate an exception report based on the information entered on the questionnaires.

14. The method of claim 1 including causing the computer system to display a summary of the assessment.

15. The method of claim 14 wherein the summary includes a radar diagram.

16. The method of claim 12 wherein the summary includes a chart with benchmarking information.

17. The method of claim 1 wherein the assessment includes an overall rating of the organization's level of reporting about itself.

18. A method comprising:
examining publicly available sources of an organization's external communications;
entering information on a questionnaire with respect to performance measures based on the examined sources to provide an indication of the organization's level of external reporting about itself; and
receiving from a computer system an assessment of the organization's level of external reporting about itself based on the information entered on the questionnaire.

19. The method of claim 18 including receiving from the computer system a quantitative assessment of the organization's level of external reporting about itself.

20. The method of claim 18 including receiving from the computer system an assessment of the organization's level of external reporting about itself compared to pre-selected criteria.

21. The method of claim 20 including receiving from the computer system an assessment of the organization's level of external reporting about itself compared to a pre-selected peer group.

22. The method of claim 18 including receiving from the computer system as assessment of the organization's level of external reporting about itself compared to recommended practices.

23. The method of claim 18 including receiving from the computer system an assessment of the organization's level of external reporting about itself for each performance measure.

24. The method of claim 18 including entering information on the questionnaire about performance measures that represent types of information that may be used by stakeholders to gain an understanding of the organization's performance.

25. The method of claim 18 including entering information on the questionnaire to reflect separately the organization's level of external reporting of quantitative and qualitative information with respect to the performance measures.

26. The method of claim 18 wherein the assessment includes an overall rating of the organization's level of reporting about itself.

27. An apparatus comprising:
a database to store templates for one or more questionnaires for use in connection with scoring performance measures based on an organization's level of reporting about itself; and
a processor coupled to the database; and
memory storing instructions that, when applied to the processor, cause the processor to:
provide a questionnaire based on the templates; and
generate an assessment of the particular organization's level of reporting about itself based on information entered on the questionnaire by a user.

28. The apparatus of claim 27 wherein the memory includes instructions that, when applied to the processor, cause the processor to generate an assessment of the organization's level of reporting about itself compared to pre-selected criteria.

29. The apparatus of claim 27 wherein the memory includes instructions that, when applied to the processor, cause the processor to generate an assessment of the organization's level of reporting about itself compared to a pre-selected peer group.

30. The apparatus of claim 27 wherein the memory includes instructions that, when applied to the processor, cause the processor to generate an assessment of the organization's level of reporting about itself compared to recommended practices.

31. The apparatus of claim 27 wherein the memory includes instructions that, when applied to the processor, cause the processor to generate an assessment of the organization's level of reporting about itself compared to criteria selected by a user.

32. The apparatus of claim 27 wherein the memory includes instructions that, when applied to the processor, cause the processor to generate a quantitative assessment of the organization's level of reporting about itself.

33. The apparatus of claim 27 wherein the memory includes instructions that, when applied to the processor, cause the processor to award predetermined numbers of points for information about performance measures reported by the organization and to generate the assessment based on the number of points awarded.

34. The apparatus of claim 33 wherein the memory includes instructions that, when applied to the processor, cause the processor to award a predetermined number of points for a particular performance measure based on whether information that corresponds to the particular performance measure that was reported by the organization includes quantitative or qualitative information.

35. The apparatus of claim 33 wherein the memory includes instructions that, when applied to the processor, cause the processor to award a number of points for a particular performance measure based on whether information that corresponds to the particular performance measure that was reported by the organization relates to a past, present or future time period.

36. The apparatus of claim 27 wherein the memory includes instructions that, when applied to the processor, cause the processor to generate an exception report based on information entered on the questionnaire.

37. The apparatus of claim 27 wherein the memory includes instructions that, when applied to the processor, cause the processor to generate a summary of the assessment, the summary including a radar diagram indicative of the organization's level of reporting.

38. The apparatus of claim 27 wherein the memory includes instructions that, when applied to the processor, cause the processor to generate an overall rating of the organization's level of reporting about itself.

39. An article including a computer-readable medium storing computer-executable instructions that, when applied to a computer system, cause the computer system to:
award predetermined numbers of points for performance measures based on answers to a questionnaire reflecting an organization's level of reporting about itself; and
generate an assessment of the organization's level of reporting about itself based on the awarded points.

40. The article of claim 39 including instructions for causing the computer system to generate an assessment of the organization's level of reporting about itself compared to pre-selected criteria.

41. The article of claim 39 including instructions for causing the computer system to generate an assessment of the organization's level of reporting about itself compared to a pre-selected peer group.

42. The article of claim 39 including instructions for causing the computer system to generate an assessment of the organization's level of reporting about itself compared to recommended practices.

43. The article of claim 39 including instructions for causing the computer system to provide multiple questionnaires each of which corresponds to different sources of information communicated by the organization.

44. The article of claim 43 including instructions for causing the computer system to generate a separate assessment of the organization's level of reporting for each questionnaire.

45. The article of claim 39 including instructions for causing the computer system to calculate scores based on points awarded to subsets of the performance measures.

46. The article of claim 39 including instructions for causing the computer system to award points separately for quantitative and qualitative information that reflects the organization's level of external with respect to the performance measures.

47. The article of claim 46 including instructions for causing the computer system to award different number of points for different types of quantitative information.

48. The article of claim 39 including instructions for causing the computer system to award a number of points for a particular performance measure based on whether information that corresponds to the particular performance measure that was reported externally by the organization relates to a past, present or future time period.

49. The article of claim 39 including instructions for causing the computer system to generate an exception report based on answers to the questionnaire.

50. The article of claim 39 including instructions for causing the computer system to generate an overall rating of the organization's level of reporting about itself.
